(19) United States
(12) Patent Application Publication
(10) Pub. No.: US 2010/0051161 A1
(43) Pub. Date: Mar. 4, 2010

(54) Nylon and steel belted off-the-road (OTR) radial tire

(75) Inventor: Maurice Taylor, Grosse Pointe Farms, MI (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(73) Assignee: Titan International, Inc., Quincy, IL (US)

(21) Appl. No.: 12/462,442

(22) Filed: Aug. 4, 2009

Related U.S. Application Data
(60) Provisional application No. 61/086,014, filed on Aug. 4, 2008.

(51) Int. Cl. B60C 9/02

(52) U.S. Cl. 152/527

(57) ABSTRACT

A radial tire is provided for use with off-the-road (OTR) vehicles. The tire includes steel belts with organic belts or an organic carcass.

The present application claims priority to application Ser. No. 61/086,014 filed Aug. 8, 2008, which is herein incorporated by reference in its entirety.

### BACKGROUND OF THE INVENTION

The present invention relates generally to radial tires, and, more specifically, to radial tires with nylon and steel belts.

Off-the-Road (OTR) tires are used for construction vehicles such as wheel loaders, backhoes, graders, trenchers, and mining vehicles. OTR tires are typically radial tires that are single-belted, single plied, with one bead on each side of the tire.

The need exists for OTR tires with more durable belts and with reduced belt edge movement with reduced stress at the belt edges.

### SUMMARY OF THE INVENTION

An object of the present invention is to provide a novel OTR tire.

A further object of the present invention is to provide a nylon and steel belted radial OTR tire.

Another object of the present invention is to provide a nylon and steel belted radial OTR tire with a nylon carcass.

To that end, a nylon and steel belted radial tire is provided.

### BRIEF DESCRIPTION OF THE DRAWINGS

FIG. 1 shows a cut away view of a typical single-bead steel plied radial tire.

FIG. 2 shows a cut away view of a nylon and steel belted tire of the present invention.

FIG. 3 shows a cut away view of a nylon and steel belted tire with nylon overlays of the present invention.

FIG. 4 shows a cut away view of a steel belted tire with nylon overlays of the present invention.

FIG. 5 shows a cut away view of a multiple bead embodiment of the tire of the present invention.

### DETAILED DESCRIPTION OF THE INVENTION

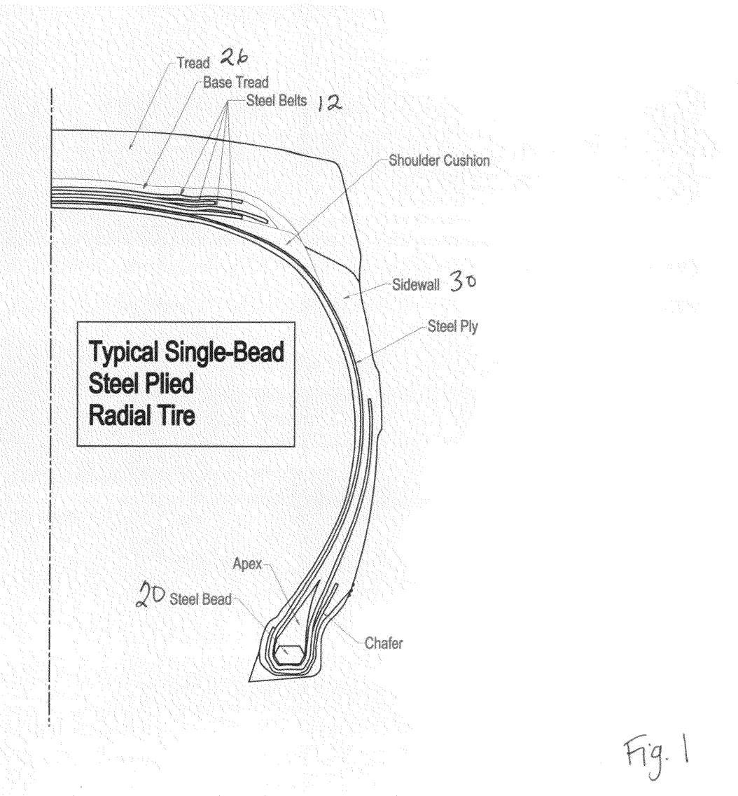

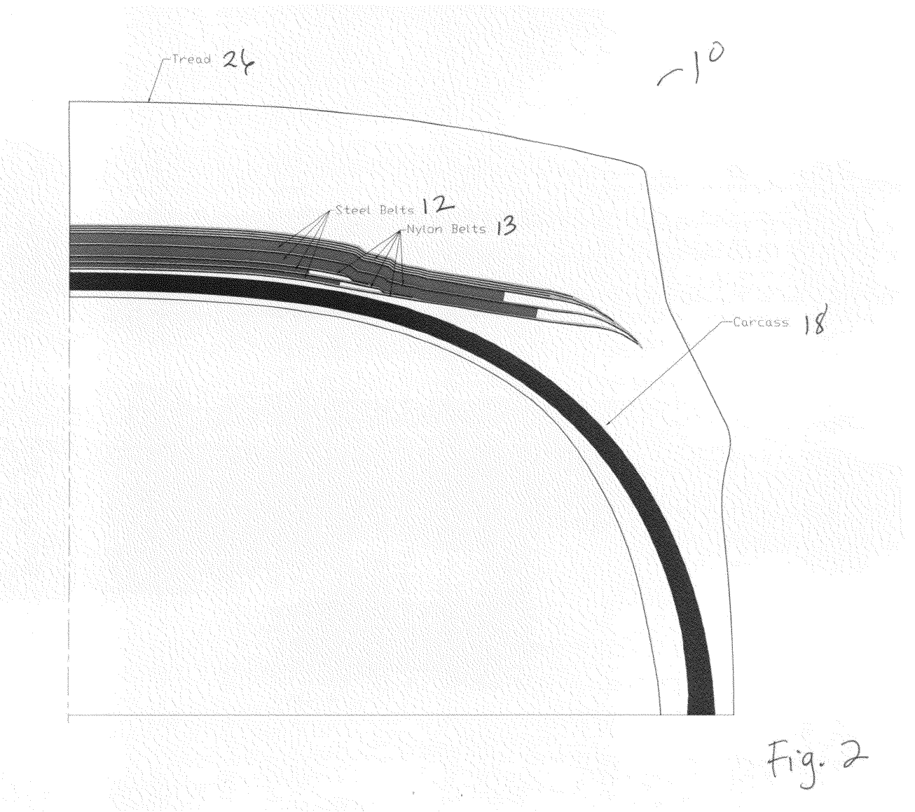

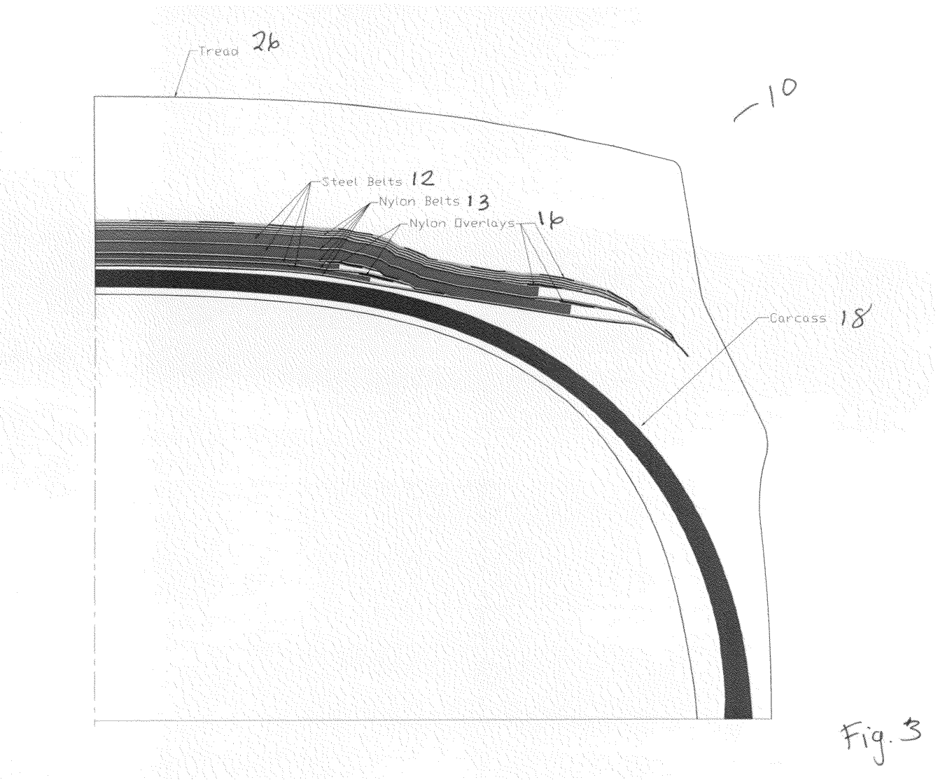

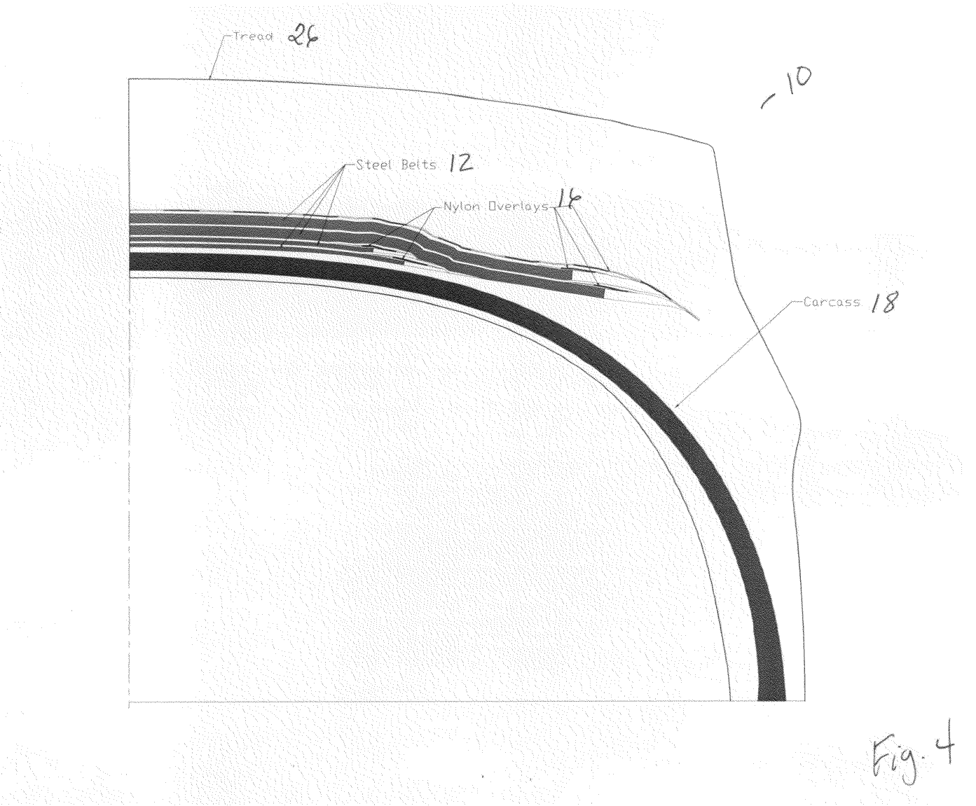

A typical single-bead, steel belted tire is shown in FIG. 1. In FIGS. 2-4, a nylon and steel belted radial tire 10 is shown. The tire 10 is a pneumatic radial tire, and most typically an off-the-road (OTR) radial tire. Nylon belts 13 are applied before, between, and/or after steel belts 12. The nylon belts 13 are most typically wider than the adjacent steel 12. The nylon belt 13 angles are approximately the same as the steel belt 12 angles.

Specifically, the tire 10 includes belts or belt plies 12 reinforced with steel cords or belt or belt plies 13 reinforced with organic cords. The organic cords are made from nylon, polyester, fiberglass, aramid, or any mixtures thereof. The belt plies may be reinforced with steel cords and helically wound overlay reinforced with organic cords or a single cord.

The tire of the present invention includes at least one pair of inextensible annular beads 20, at least one carcass ply wrapped around the beads, a belt package comprising belt plies disposed over the carcass 18 in the crown area of the tire 10, a tread 26 disposed over the beads 20, and sidewalls 30 disposed between the tread 26 and the beads 20.

The steel belts 12 are comprised of substantially parallel longitudinal reinforcement cords which are oriented with an angle which ranges from 15 degrees to 30 degrees with respect to the equatorial plane of the tire 10.

The organic belts 13 are comprised of substantially parallel longitudinal reinforcement cords which are oriented with similar angle as the adjacent steel belt with respect to the equatorial plane of the tire 10. The organic cords are typically comprised of dtex values ranging from 99/2 to 2800/2. The organic cords are generally spaced between 14 ends per inch and 32 ends per inch. The widths of the organic cords are typically around 25 mm wider than the adjacent steel belt.

There may also be a helically wound overlay 16 reinforced with one or more organic cords. Specifically, the overlay 16 is a helically wound strap reinforced with organic cords or a singled helically wound cord. The overlay is applied to the edges of the steel belts 12 or over the entire belt package. The overlay is typically oriented at an angled between 0 and 5 degrees from the equatorial plane of the tire 10. In one example the overlay 16 over the belt edges has a typical width of 50 mm and extends past the adjacent belt edge by 10 mm. The overlay 16 over the belt edges can be applied to one, many or all steel belt 12 edges. The overlay 16 over the entire belt package has a typical width 20 mm wider than the widest steel belt.

The nylon overlay 16 on steel belt edges may cover the entire belt package in off the road (OTR) radial tires. The nylon cords are wrapped circumferentially around the tire. The nylon overlay 16 is on top of individual belts or over the entire belt package.

The benefits to this new OTR tire 10 include increased belt durability. It reduces socketing of the belt edge and increases strength of the belt package. This invention improves resistance to cuts and increases the rigidity of the belt package which improves wear characteristics.

Further, this design increases hoop strength of the green belt packed, which aids in tire building. The invention reduces tire growth due to inflation pressure and due to centrifugal forces. It also reduces belt edge movement due to centrifugal forces. Finally, the invention reduces stress at the belt edges.

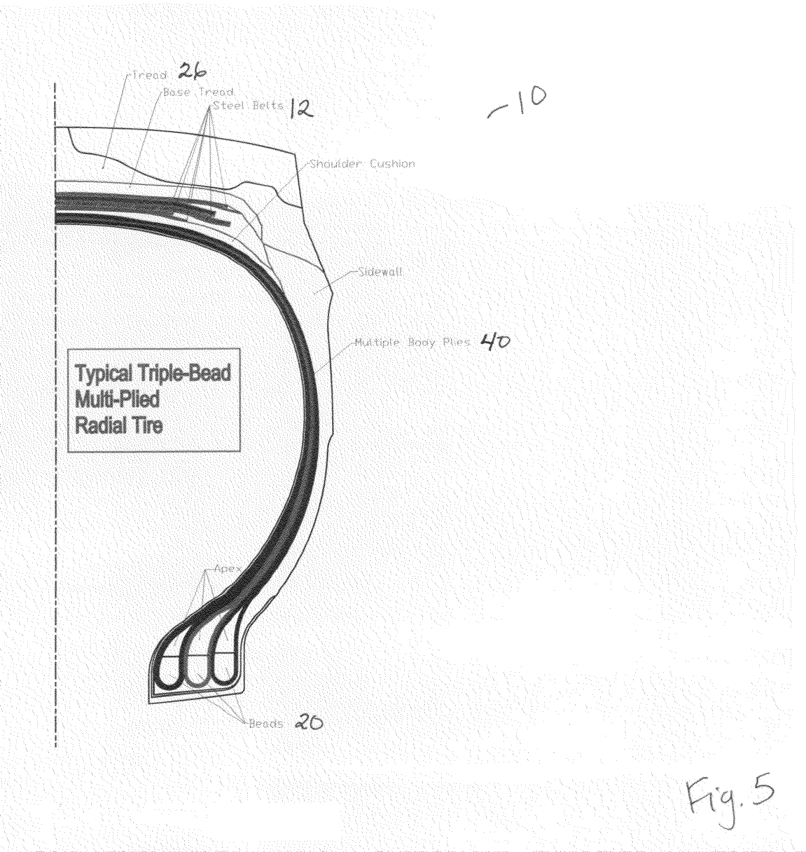

The tire of the present invention may also include more than one pair of beads 20, as shown in FIG. 5. In this embodiment, the tire 10 includes at least two pairs of beads 20 that are inextensible and annular, multiple carcass plies wrapped around the beads 20, a belt package made of belt plies disposed over the carcass in the crown aread of the tire, a tread disposed over the belts, and sidewalls disposed between the tread and the beads 20. The carcass plies are comprised of substantially parallel longitudinal reinforcement organic cords. The organic carcass plies are typically oriented between +10 and −10 degrees from absolute radial. The angles of subsequent plies are typically the negative of each other. There are generally at least two carcass plies folded up around each pair of inextensible annular beads 20. The organic cords are typically comprised of dtex values ranging from 900/2 to 2800/2. The organic cords are typically spaced between 14 ends per inch and 32 ends per inch. A multiple bead tire is disclosed in application Ser. No. 12/354,711, which is herein incorporated by reference in its entirety.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention. For example, any measurements, angles, etc. described are in no way limiting. These measurements and angles are intended to describe a representative embodiment of the invention, but the tire of the present invention is not limited to such measurements and angles. Further, organic is used to describe the material(s) that belts, plies and cords are made from in the present invention. Organic includes nylon, polyester, fiberglass, aramid, or any mixtures thereof.

1. A radial tire comprising:
a) at least one pair of axially spaced bead portions;
b) a tread disposed over the bead portion;
c) sidewalls disposed between the tread and the bead portions;
d) a carcass; and
e) a belt package disposed disposed over the carcass, wherein the belt package further comprises at least one steel belt.

2. The tire of claim 1, wherein the belt package further comprises at least one organic belt.

3. The tire of claim 1, wherein the belt package further comprises an organic overlay.

4. The tire of claim 1, wherein the tire is an off-the-road tire.

5. The tire of claim 2, further comprising a plurality of pairs of axially spaced bead portions.

6. The tire of claim 3, further comprising a plurality of pairs of axially spaced bead portions.
